(19) United States
(12) Patent Application Publication
(10) Pub. No.: US 2014/0245409 A1
(43) Pub. Date: Aug. 28, 2014

(54) Extension of the Attributes of a Credential Request

(71) Applicants: Rainer Falk, Poing (DE); Steffen Fries, Baldham (DE)

(72) Inventors: Rainer Falk, Poing (DE); Steffen Fries, Baldham (DE)

(21) Appl. No.: 14/189,860

(22) Filed: Feb. 25, 2014

(30) Foreign Application Priority Data
Feb. 26, 2013 (DE) DE 102013203101.7

(51) Int. Cl. H04L 29/06

(52) U.S. Cl. CPC H04L 63/0823
USPC 726/6

(57) ABSTRACT

In order to issue a security credential, a client of a system is configured to send a credential request in order to have a credential issuer prepare a security credential. The credential request is received by a credential attribute intermediary connected between the client and the credential issuer. At least one attribute of the requesting client is ascertained by the credential attribute intermediary. The at least one attribute ascertained by the credential attribute intermediary is confirmed to the credential issuer. The security credential is issued by the credential issuer based on the credential request received by the credential attribute intermediary and based on the at least one attribute confirmed by the credential attribute intermediary.

This application claims the benefit of DE 10 2013 203 101.7, filed on Feb. 26, 2013, which is hereby incorporated by reference in its entirety.

### BACKGROUND

The present embodiments relate to the issuing of a security credential.

Security credentials such as, for example, digital certificates, a security token in the form of a data structure, or a hardware security token with a stored security token data structure are provided in order to be able to use security mechanisms. A security infrastructure provides such security credentials. In automation environments, devices increasingly use certificates and associated private keys for authentication or else for negotiating security parameters for protecting the communication.

For device-oriented security credentials, a highly automated security infrastructure is provided. In this case, the key material may be produced via the devices themselves, and a certificate request (e.g., certificate signing request (CSR)) may be used to request a certificate that is subsequently used. The location of the device may be an important piece of information.

A digital certificate (e.g., based on X.509v3) is a data structure that is protected with a digital signature and ties a public key to certain attributes (e.g., name, country, organization, etc.) in a manner protected against manipulation. An overview is provided by http://en.wikipedia.org/wiki/Public_key_certificate or RFC5280 (http://www.ietf.org/rfc/rfc5280.txt), for example. A digital certificate may be issued not just for natural persons but also for devices (e.g., device certificate).

A public key infrastructure that issues digital certificates is known (e.g., see http://en.wikipedia.org/wiki/Public-key_infrastructure). FIG. 1 also shows a known public key infrastructure 100 in which a user 101 makes a CSR 102 to a registration authority (RA) 103. Following a check by the RA 103, the request is forwarded to the certificate authority 104, which uses a private key 108 of the certificate authority 104 to issue a digital certificate 105 (e.g., based on X.509), digitally signs the certificate in act 107 and provides the certificate for the user 101. In this case, the RA 103 provides that a particular public key 106 actually belongs to a particular person (e.g., by inspecting an identity card). A key pair including the public key 106 and a private key has been provided by the user infrastructure 111 in method act 110 in this case. It is also known in this case that the check by the RA 103 is made not by a person but rather in automated fashion by a software component (http://www.securemetric.com/securepki.php AutoRA).

A public register 109 is used to provide the public key certificates of the user 101 and of the certification authority 104 and also a revocation list.

In practice, digital certificates are issued by a certification authority (e.g., certificate authority or CA). To this end, a client sends a request to the CA or the RA. Protocols for automatic certificate enrollment are, for example, certificate signing request CSR according to PKCS#10 (see http://www.rsa.com/rsalabs/node.asp?id=2132 or http://tools.ietf.org/html/rfc2986), SCEP simple certificate enrollment protocol (see http://en.wikipedia.org/wiki/Simple_Certificate_Enrollment_Protocol or http://datatracker.ietf.org/doc/draft-nourse-scep/), and XML key management specification (see http://www.w3.org/TR/xkms2/).

In this case, a piece of CSR information has the following structure:

```
CertificationRequestInfo:
  CertificationRequestInfo ::= SEQUENCE {
    version INTEGER { v1(0) } (v1,...),
    subject Name,
    subjectPKInfo SubjectPublicKeyInfo{{ PKInfoAlgorithms }},
    attributes [0] Attributes{{ CRIAttributes }}
  }
  SubjectPublicKeyInfo { ALGORITHM : IOSet} ::= SEQUENCE {
    algorithm AlgorithmIdentifier {{IOSet}},
    subjectPublicKey BIT STRING
  }
```

A piece of CSR information thus essentially contains a public key (subjectPublicKey) and an associated name (subject) and attributes for describing the subject (attributes).

A CSR request (CSR-Request) contains the CSR information that is protected by a digital signature:

```
CertificationRequest ::= SEQUENCE {
    certificationRequestInfo CertificationRequestInfo,
    signatureAlgorithm AlgorithmIdentifier{{ SignatureAlgorithms }},
    signature BIT STRING
```

Generally, a certificate request may be protected by a password, by a cryptographic checksum, by a signature or the like, so that only the authorized client may separately request a certificate. In this case, the actual CSR is once again packed into a PKCS#7 structure in order to provide the confidentiality of the password used.

The relevant prior art may be presented in abstracted form with reference to FIGS. 2A-2C as follows.

FIG. 2A shows a method and an infrastructure 200 for issuing a certificate. A CSR 202 sent to a combined RA/CA unit 203/204 is used by the client 201 to prescribe attributes a1, a2, a3 and to specify a name. In this case, the name may also be regarded as a specific attribute. The cryptographic checksum 205 (Checksum) of the CSR 202 may be a digital signature 205 from the client 201. The certification authority 204 receives the CSR 202, checks the CSR 202, takes the CSR 202 as a basis for preparing a certificate 206 signed by a CA signature 207 and makes the certificate available to the client 201. In addition, the CSR 202 and the certificate 206 may be encrypted by a public key pk of the RA/CA unit 203/204.

FIG. 2B shows another variant of a method for issuing a certificate, which is used in the case of the SCEP protocol, for example, and which involves the client 201 using a password in order to authenticate and authorize the CSR 212. In contrast to the variant shown in FIG. 2A, the password is transmitted as an attribute (e.g., a3) (in this case, the password is not transferred to the issued certificate 206a as an attribute). The certificate request 212 is additionally packed into a PKCS#7 data structure 219 and encrypted with the public key 218 of the CA 204 in order to protect the confidentiality (e.g., of the password used). Accordingly, it would also be possible to use XML encryption, for example. The certificate 206a includes a CA signature 207a.

FIG. 2C shows another variant, in which a separate RA 203 is provided, as a result of which the check is performed by the upstream RA 203. The RA 203 receives the CSR 202, checks the CSR 202, and sends the CSR 202 to the CA 204. The CA 204 receives and checks the CSR 202 and issues and provides the certificate 206. In this case too, the CSR 202 and the certificate 206 may also be encrypted by a public key pk.

### SUMMARY AND DESCRIPTION

The scope of the present invention is defined solely by the appended claims and is not affected to any degree by the statements within this summary.

The solutions of the prior art have the disadvantage that the client needs to know attributes when the client makes a certificate request. It is therefore not possible to use attributes that the client does not know. By way of example, these attributes may be related to the environment in which the client is used and, by way of example, describe an installation location or particular restrictions for the client.

The present embodiments may obviate one or more of the drawbacks or limitations in the related art. For example, the disadvantage discussed above may be overcome.

According to one embodiment of a method, a client sends a credential request in order to have a credential issuer prepare a security credential. The credential request is received by a credential attribute intermediary connected between the client and the credential issuer. At least one attribute of the requesting client is ascertained by the credential attribute intermediary. The at least one attribute ascertained by the credential attribute intermediary is confirmed to the credential issuer. Based on the credential request received by the credential attribute intermediary and based on the at least one attribute confirmed by the credential attribute intermediary, the credential issuer issues the security credential.

One embodiment of the system includes a client, a credential issuer and a credential attribute intermediary connected between the client and the credential issuer. The client is adapted to send a credential request in order to have the credential issuer prepare the security credential. The credential attribute intermediary is adapted to receive the credential request and to ascertain at least one attribute of the requesting client and to confirm the attribute to the credential issuer. The credential issuer is adapted to prepare the security credential based on the credential request received by the credential attribute intermediary and based on the at least one attribute confirmed by the credential attribute intermediary.

### BRIEF DESCRIPTION OF THE DRAWINGS

FIG. 1 shows a known method for issuing a certificate;

FIGS. 2A-2C show known variants of a method for issuing a certificate;

FIG. 3 shows one embodiment of a method and a system for issuing a security credential;

FIG. 4 shows variants for the method and system; and

FIG. 5 shows one embodiment of a system and a method.

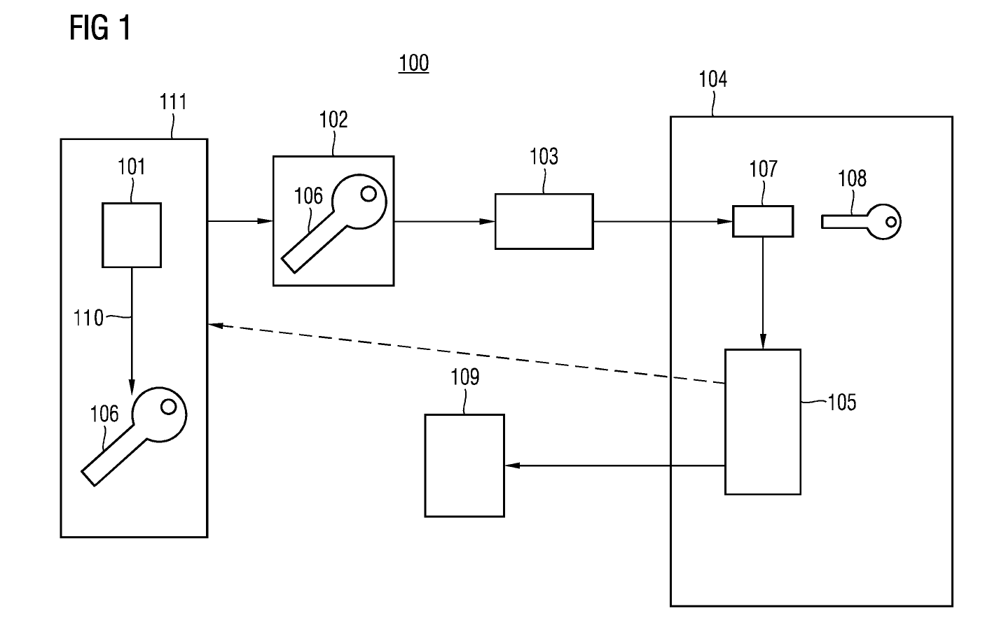

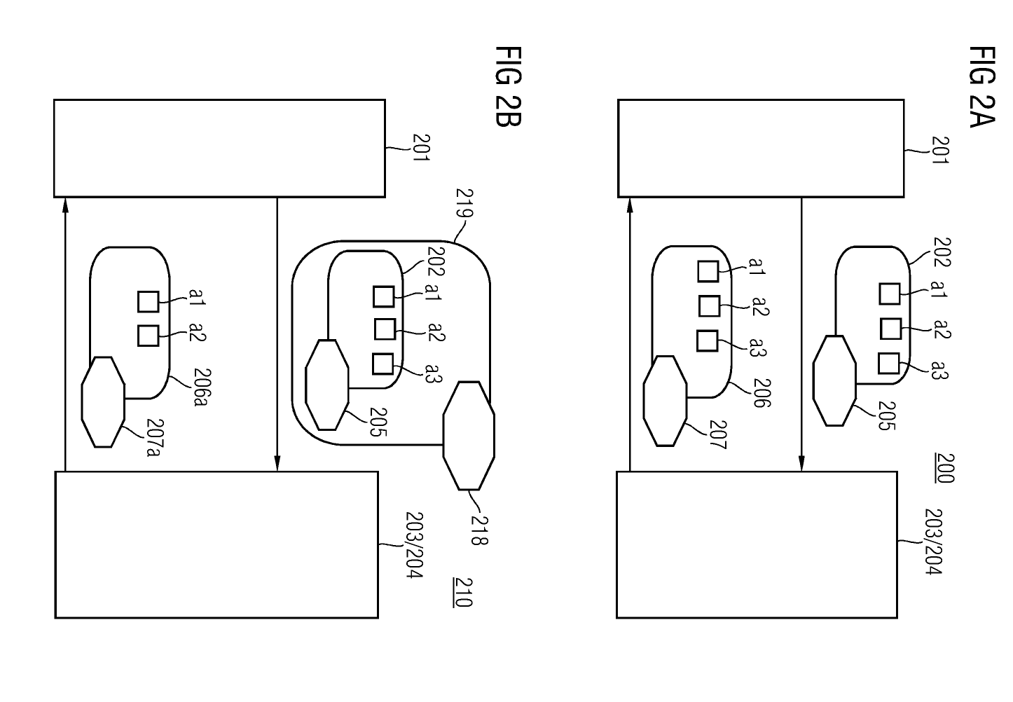

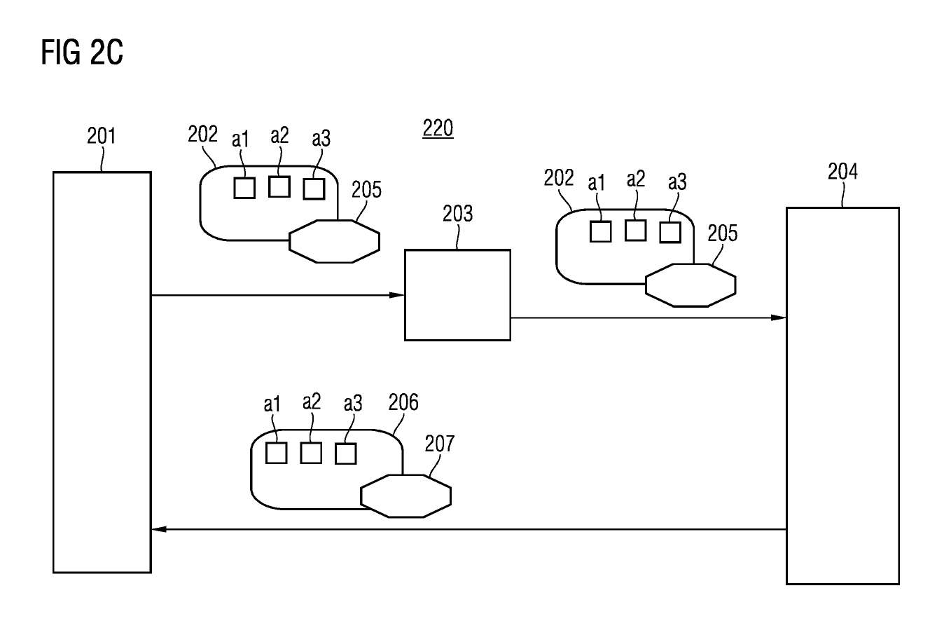

### DETAILED DESCRIPTION

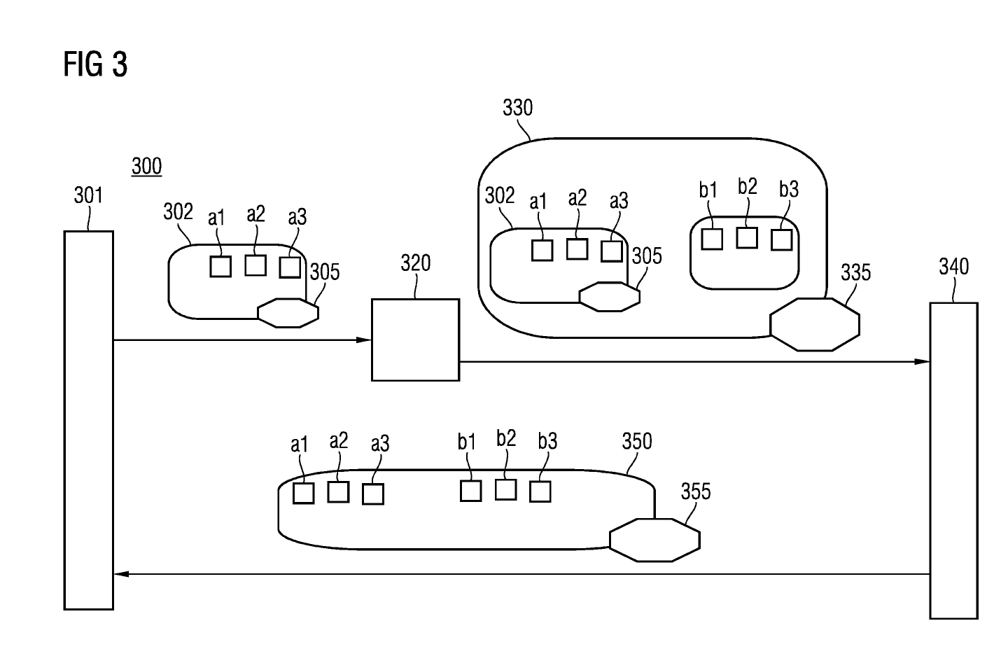

FIG. 3 shows one embodiment of a system 300 in the form of a public key infrastructure that issues security credentials 350. The system 300 includes a client 301, a credential issuer 340 and a credential attribute intermediary 320 connected between the client 301 and the credential issuer 340. The client 301 may be any number of computing devices including a processor (e.g., a desktop or a laptop computer). The credential issuer 340 and the credential attribute intermediary 320 may be any number of computing devices each including a processor (e.g., servers). In order to have the credential issuer 340 issue a security credential 350 in the form of a certificate, the client 301 sends a credential request 302. The credential attribute intermediary 320 receives the credential request 302 and, as a reaction thereto, automatically ascertains one or more attributes b1, b2, b3 of the requesting client and confirms the attribute(s) to the credential issuer 340. The credential issuer 340 issues the security credential 350 and also, optionally, further security credentials based on the credential request 302 received by the credential attribute intermediary 320 and based on the attributes b1, b2, b3 confirmed by the credential attribute intermediary 320.

In addition, the credential request 302 and the security credential 350 may be encrypted by a public key pk of the credential issuer 340.

In the embodiment shown in FIG. 3, the credential attribute intermediary 320 confirms the at least one ascertained attribute b1, b2, b3 to the credential issuer 340 via the credential attribute intermediary 320 producing an extended credential request 330 and sending the extended credential request 330 to the credential issuer 340. The extended credential request 330 includes the credential request 302 and the at least one attribute b1, b2, b3 ascertained by the credential attribute intermediary 320.

In one embodiment, the extended credential request 330 includes the unaltered credential request 302. In other words, the extended credential request 330 includes not only the attributes b1, b2, b3 but also the credential request 302, including the attributes a1, a2, a3. In other words, the credential attribute intermediary 320 may be regarded as an extension that ascertains the extended attributes b1, b2, b3 and confirms the extended attributes b1, b2, b3 to the credential issuer 340.

In the embodiment shown in FIG. 3, the credential attribute intermediary 320 confirms the at least one ascertained attribute b1, b2, b3 to the credential issuer 340 using a checksum 335. Calculation of the checksum 335 includes the credential request 302 and the at least one attribute b1, b2, b3. In order to be able to distinguish the checksum 335 better from the checksum 305, the checksum 335 is subsequently also called CAI checksum 335 (CAI for credential attribute intermediary or else for certificate attribute intermediary). In some embodiments, the CAI checksum 335 of the extended credential request 330 is a digital signature (e.g., an RSA signature, a DSA signature or an EC-DSA signature). However, the CAI checksum 335 may also be a symmetrical cryptographic checksum (e.g., an HMAC-SHA1 checksum). The extended certification request may be implemented as a PKCS#7 data structure or as an XML data structure, for example. In another variant, the credential attribute intermediary 320 transmits the credential request 302 together with the extended attributes b1, b2, b3 to the credential issuer 340 via an SSL/TLS-protected transmission link (e.g., as an HTTP POST, HTTP GET or as a REST or SOAP message). In some embodiments, the CAI checksum 335 is therefore a cryptographic integrity code or a digital signature.

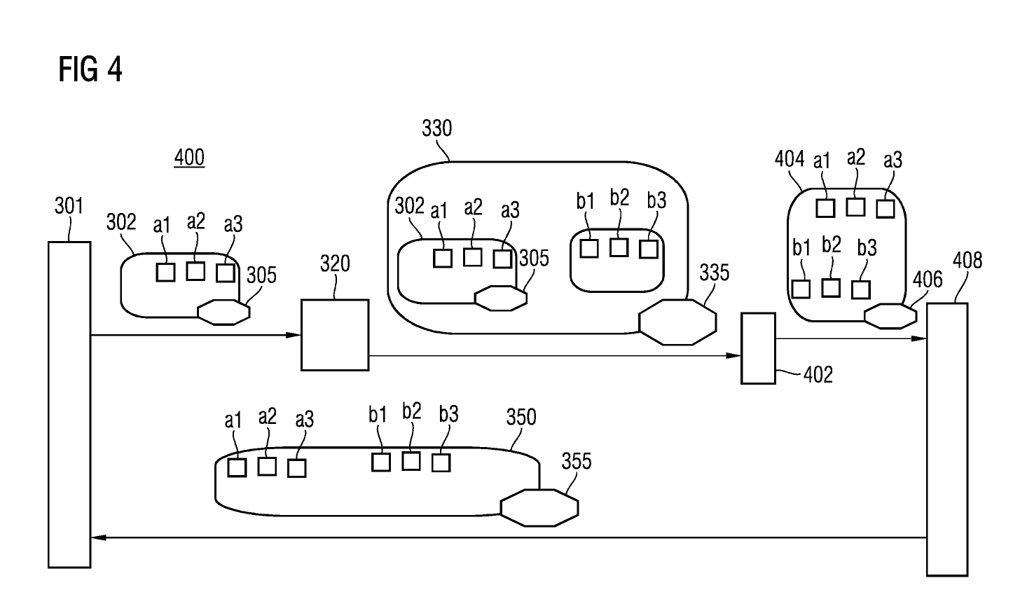

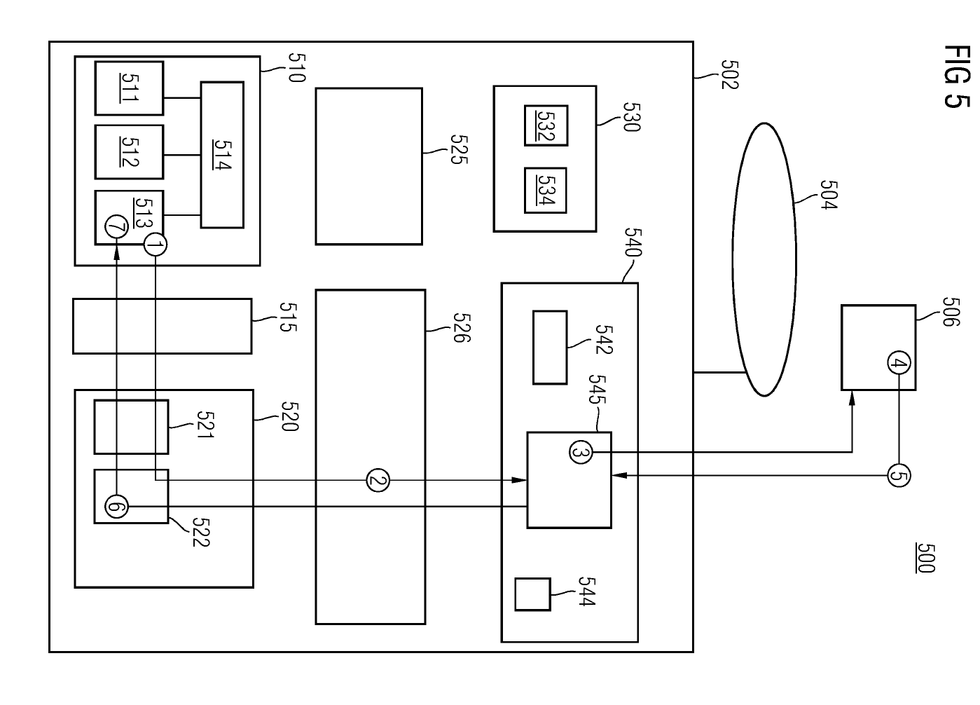

In the system 400 shown in FIG. 3, the credential issuer 340 includes a registration authority and a credential authority. The credential issuer 340 checks the extended credential request, which includes the credential request, and issues and provides the security credential. FIG. 4 shows variants with a separate registration authority 402 in relation to the embodiments described with reference to FIG. 3. These variants work similarly to the embodiments described with reference to FIG. 3, but the registration authority (RA) 402 and the certificate authority (CA) 408 are separate units. The RA 402 receives and checks the extended credential request 330 in the form of an extended certificate request. The RA also checks the certificate request that the extended certificate request 330 contains, and generates therefrom a modified extended certificate request 404 that includes the attributes a1, a2, a3, coded into the credential request 302 by the client 301, and also the attributes b1, b2, b3 of the client 301 that are ascertained by the credential attribute intermediary 320 in order to confirm the attributes to the CA 408. The modified extended certificate request 404 is protected by an RA checksum 406 allocated by the registration authority. The CA 408 receives and checks the certificate request 330 and issues and provides the certificate 350. In this case too, the certificate request 330 and the certificate 350 may also be encrypted by a public key pk.

Hence, according to the embodiments shown in FIGS. 3 and 4, a certificate 350 is issued for the client 301. An interposed credential attribute intermediary 320, as an attribute confirmation component that is separate from the client, ascertains at least one attribute b1, b2, b3 of the requesting client and confirms the at least one attribute b1, b2, b3 to the CA or to the RA.

In the embodiments shown in FIGS. 3 and 4, the credential request 302 sent by the client 301 includes further attributes a1, a2, a3 that are coded into the credential request 302 by the client 301. Similarly, the client 301 may provide the credential request 302 with a checksum 305 that is used as a digital signature for the client 301.

In one embodiment, the at least one attribute b1, b2, b3 codes an association of the client 301 with a zone, with a group, with a place of issue, with an administrative management area and/or with a purpose of use. In this case, the place of issue may be geographical or organizational.

In one variant, the credential attribute intermediary 320 specifies a format of the security credential 350, an attribute of the security credential 350 or a crypto-algorithm that is to be used by the credential issuer 340, 408 for credential issue. By way of example, the certificate format or the crypt-algorithms that are to be used by a certificate authority of the credential issuer 340 is/are specified by the credential attribute intermediary 320. The certificate format, at least one certificate attribute (e.g., a coded-in purpose of use or a coded-in validity period), the security credential, or the crypto-algorithms that are to be used by the certificate authority may be specified by the credential attribute intermediary.

In another variant, the device identifier (name) allocated by the manufacturer is replaced by a device identifier allocated by the operator or is augmented thereby. In this case, replacement may occur only if the credential request 302 is not transmitted in protected form. In other words, a device identifier sent with the credential request 302 is replaced or augmented by a device identifier allocated by the credential attribute intermediary 320. In one embodiment, the device identifier allocated by the credential attribute intermediary is the at least one attribute of the requesting client that is ascertained by the credential attribute intermediary, or is included by this attribute.

The request 302 from the client 301 may be protected, for example, with a general client certificate (e.g., device certificate). This may be a device certificate installed by the manufacturer, for example. For example, the requested certificate may be an operator certificate that is associated with the operator that operates the device. In one embodiment, the credential request 302 from the client 301 is protected with an existent client key pair (e.g., certificate/public key and corresponding private key). The client key pair includes a client certificate that is, for example, a device certificate installed by the manufacturer of the client or an operator certificate associated with the operator of the client. In this case, the operator may be the operator of the credential attribute intermediary 320.

As an alternative, the credential request 302 from the client is protected with an existent shared secret between the client 301 and the credential issuer 340.

The security credential 350 may be a digital certificate. By way of example, this may be a certificate based on X.509v3, but may also be a security token (e.g., an SAML assertion). In this case, the credential request may also be a certificate request (CR) or a certificate signing request (CSR), the credential attribute intermediary may be a certificate attribute intermediary, and the credential issuer may be a certificate issuer or certificate authority. Embodiments extend the attributes of a certificate signing request on the transmission path between client and certificate issuer.

In the embodiments shown by FIGS. 3 and 4, the security credential 350 includes the attributes a1, a2, a3 coded into the credential request 302 by the client 301, and also the attributes b1, b2, b3 of the client 301 that are ascertained by the credential attribute intermediary 320 and that are confirmed to the credential issuer 340. In addition, the security credential 350 is protected by a CA signature 355 produced by the credential issuer 350.

According to further embodiments, an operator-specific device certificate may be requested and installed automatically based on a general device certificate. An operator-specific device certificate that contains the details relating to an incorrect operator may be prevented from being requested.

In the case of an application within energy automation, this allows, by way of example, a simplified association to be made between IEDs (intelligent electronic devices-field devices) and the stations in the case of automated deployment, or incorrect configurations may be identified.

FIG. 5 shows one embodiment of a system 500 and one embodiment of a method that shows the process when new IEDs are introduced into a substation. The system 500 includes a physical substation security perimeter 502, a utility communications network 504, a certificate authority (CA) 506, a station bus zone 510, a remote serial configuration zone 515, a serial intelligent electronic devices process zone 520, an automation zone 525, a remote access zone 526, a file server 532 and a de-militarized zone 540. The station bus zone 510 includes a device based on IEC 61850 and a plurality of field devices (e.g., IEDs; IED 511, 512, 513). Similarly, the serial IED process zone includes a plurality of IEDs 521, 522. The de-militarized zone 540 includes a web server 542, remote access server 545 and a terminal server 544. The system 500 is a further development of the system shown on page 39, FIG. 14, of IEC/TR 62351-10: “Power systems management and associated information exchange—Data and communications security—Part 10: Security architecture guidelines,” and may also include the further parts of the system.

According to one embodiment, the method includes the acts shown in FIG. 5.

In act 1, the IED 513 generates key material in the form of a key pair (public/private key). In addition, the IED 513 generates a credential request in the form of a certificate signing request (CSR) 302.

In act 2, the IED 513 sends the CSR 302 to the remote access server 545 in the form of a local VPN gateway.

In act 3, the remote access server 545 in the form of a local VPN gateway checks and signs the CSR 302. The remote access server 545 ascertains at least one attribute b1, b2, b3 of the requesting IED 513 and confirms the attribute to the CA 506. The remote access server 545 in the form of a local VPN gateway thus acts as a credential attribute intermediary 320 in this case.

In act 4, the CA 506 (or a CA/RA unit) checks the signature of the VPN gateway 545 and checks the CSR.

In act 5, if good, the CA 506 issues a certificate 350 and sends the certificate 350 to the substation 502.

In act 6, the substation 502 or the local VPN gateway 545 routes the certificate 350 to the IED 513.

In act 7, the IED 513 installs the certificate 350. The IED 513 thus works as a client 301.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for issuing a security credential, the method comprising:
sending, by a client, a credential request in order to have a credential issuer prepare the security credential;
receiving the credential request by a credential attribute intermediary connected between the client and the credential issuer;
ascertaining, by the credential attribute intermediary, at least one attribute of the client;
confirming the at least one attribute ascertained by the credential attribute intermediary to the credential issuer;
issuing, by the credential issuer, the security credential based on the credential request received by the credential attribute intermediary and based on the at least one attribute confirmed by the credential attribute intermediary.

2. The method of claim 1, wherein the ascertaining comprises ascertaining the at least one attribute automatically based on the reception of the credential request.

3. The method of claim 1, wherein the confirming comprises:
producing, by the credential attribute intermediary, an extended credential request; and
sending the extended credential request to the credential issuer or to a registration authority assisting the credential issuer,
wherein the extended credential request comprises the credential request and the at least one attribute of the requesting client.

4. The method of claim 1, wherein the credential attribute intermediary confirms the at least one ascertained attribute to the credential issuer using a checksum, and
wherein calculation of the checksum comprises the credential request and the at least one attribute.

5. The method of claim 4, wherein the checksum is a cryptographic integrity code or a digital signature.

6. The method of claim 1, wherein the at least one attribute codes an association of the client with a zone, a group, a place of issue, an administrative management area, a purpose of use, or a combination thereof.

7. The method of claim 1, further comprising specifying, by the credential attribute intermediary, a format of the security credential, an attribute of the security credential, or a crypto-algorithm that is to be used by the credential issuer for credential issue.

8. The method of claim 1, further comprising replacing or augmenting a device identifier sent with the credential request with a device identifier allocated by the credential attribute intermediary.

9. The method of claim 1, wherein the credential request from the client is protected with an existent client key pair,
wherein the client key pair comprises a client certificate or an operator certificate associated with an operator of the client.

10. The method of claim 9, wherein the client key pair comprises the client certificate, which is a device certificate installed by a manufacturer of the client.

11. The method of claim 1, wherein the credential request from the client is protected with an existent shared secret between the client and the credential issuer.

12. The method of claim 1, wherein the security credential is a digital certificate.

13. A system for issuing a security credential, the system comprising:
a client;
a credential issuer; and
a credential attribute intermediary connected between the client and the credential issuer,
wherein the client is configured to send a credential request in order to have the credential issuer prepare the security credential,
wherein the credential attribute intermediary is configured to receive the credential request, to ascertain at least one attribute of the requesting client, and to confirm the at least one attribute to the credential issuer, and
wherein the credential issuer is configured to prepare the security credential based on the credential request received by the credential attribute intermediary and based on the at least one attribute confirmed by the credential attribute intermediary.

14. The system of claim 13, wherein the credential attribute intermediary is configured to ascertain the at least one attribute automatically based on the reception of the credential request.

15. The system of claim 13, wherein the credential attribute intermediary is configured to confirm the at least one ascertained attribute to the credential issuer via the credential attribute intermediary producing an extended credential request and sending the extended credential request to the credential issuer or to a registration authority assisting the credential issuer, and
wherein the extended credential request comprises the credential request and the at least one attribute of the requesting client.

16. The system of claim 13, wherein the credential attribute intermediary is configured to confirm the at least one ascertained attribute to the credential issuer by a checksum, and
wherein calculation of the checksum comprises the credential request and the at least one attribute.

17. The system of claim 16, wherein the checksum is a cryptographic integrity code or a digital signature.

18. The system of claim 13, wherein the at least one attribute codes an association of the client with a zone, a group, a place of issue, an administrative management area, a purpose of use, or a combination thereof.

19. The system of claim 13, wherein the credential attribute intermediary specifies a format of the security credential, an attribute of the security credential, or a crypto-algorithm that is to be used by the credential issuer.

20. The system of claim 13, wherein the credential attribute intermediary is configured to replace or augment a device identifier sent with the credential request with a device identifier allocated by the credential attribute intermediary.

21. The system of claim 13, wherein the credential request from the client is protected with an existent client key pair, and
wherein the client key pair comprises a client certificate that is a device certificate installed by a manufacturer of the client, or an operator certificate associated with an operator of the client.

22. The system of claim 13, wherein the credential request from the client is protected with an existent shared secret between the client and the credential issuer.

23. The system of claim 13, wherein the security credential is a digital certificate.
